(19) United States
(12) Patent Application Publication
(10) Pub. No.: US 2026/0025540 A1
(43) Pub. Date: Jan. 22, 2026

(54) TECHNIQUES FOR IMPROVING QUALITY OF EXPERIENCE WHEN STREAMING LIVE EVENTS

(71) Applicant: NETFLIX, INC., Los Gatos, CA (US)

(72) Inventors: Xiaomei LIU, Cupertino, CA (US); Cyril Denis Mario CONCOLATO, Palo Alto, CA (US); Robert Harold Hunter FORD, Golden Oak, FL (US); Flavio Ribeiro Nogueira BARBOSA, New York, NY (US); Thomas SYMBORSKI, Norfolk, VA (US)

(21) Appl. No.: 18/777,157

(22) Filed: Jul. 18, 2024

(51) Int. Cl. H04N 21/24; H04N 21/2187; H04N 21/232; H04N 21/845

(52) U.S. Cl. CPC H04N 21/2407; H04N 21/2187; H04N 21/232; H04N 21/8456

(57) ABSTRACT

In various embodiments, an origin application streams live events. The origin application determines that a first version of a first segment of a stream that is associated with a live event includes one or more errors. In response, the origin application retrieves from a memory a second version of the first segment. The origin application determines that the second version of the first segment does not include any errors. The origin application transmits the second version of the first segment to a content delivery network.

### BACKGROUND

### Field of the Various Embodiments

The various embodiments relate generally to computer science and to video and media streaming technology and, more specifically, to techniques for improving quality of experience when streaming live events.

### DESCRIPTION OF THE RELATED ART

In some approaches to streaming media content to endpoint devices, a streaming pipeline is used to encode discrete portions of a media source across different sets of encoding parameters to generate segments of different media streams, where each “stream” constitutes a different encoded version of the entire media source. The segments are typically stored in memory associated with one or more origin servers and subsequently streamed to various client devices, on-demand, via a content delivery network (CDN) of caching servers.

This type of “on-demand” delivery process works reasonably well when streaming pre-generated streams for static media sources, such as movie videos. However, when streaming live events, streams are incrementally generated based on live media feeds and distributed segment-by-segment throughout a given live event. If a problem arises in the streaming pipeline, then the streaming pipeline can fail to generate one or more segments, altogether, and/or can generate one or more segments that include errors.

In an attempt to mitigate the above issue, some systems implement dual streaming pipelines. Upon receiving a request for a segment, an origin server attempts to retrieve from memory a version of the segment that was received from a preferred streaming pipeline. If the origin server successfully retrieves that “preferred” version of the segment, then the origin server delivers that preferred version of the segment to the CDN. Otherwise, the origin server attempts to retrieve from memory a version of the segment that was generated by and received from an alternate streaming pipeline. If the origin server successfully retrieves that “alternate” version of the segment, then the origin server delivers that alternate version of the segment to the CDN. If the origin server is unable to retrieve from memory either a preferred version or an alternate version of the segment, then the origin server responds to the request for the segment with an error message.

One drawback of the above approach is that, if a preferred version of a segment exists but includes one or more errors, then the origin server delivers the preferred version of the segment to the CDN even if an alternate version of the same segment exists and is error-free. Because the CDN ends up delivering the preferred version of the segment to client devices, even when that preferred version includes errors, the overall viewing qualities experienced by users of the client devices can be substantially reduced. For example, if the preferred versions of one or more segments exist but are missing frames, then users of the client devices could unnecessarily experience frame freezes, black frames, audio/video synchronization issues, and/or other playback issues that diminish the overall viewing quality and experience.

As the foregoing illustrates, what is needed in the art are more effective techniques for streaming live events.

### SUMMARY

One embodiment sets forth a computer-implemented method for streaming live events. The method includes determining that a first version of a first segment of a stream that is associated with a live event includes one or more errors; in response, retrieving from a first memory a second version of the first segment; determining that the second version of the first segment does not include any errors; and transmitting the second version of the first segment to a content delivery network (CDN).

At least one technical advantage of the disclosed techniques relative to the prior art is that, with the disclosed techniques, the number of segments having errors that are delivered to client devices via a CDN can be reduced. Accordingly, implementing the disclosed techniques can substantially improve the overall viewing quality experienced by users of client devices who are watching a live event. In that regard, with the disclosed techniques, if a preferred version of a requested segment exists but includes one or more errors and an alternate version of the requested segment exists and is error-free, then the alternate version of the requested segment is delivered to the client devices via the CDN instead of the preferred version. As a result, with the disclosed techniques, the number of segments having errors that are ultimately delivered to client devices can be reduced relative to prior art techniques that preferentially deliver preferred versions of segments irrespective of any errors included in the preferred versions of the segments. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the origin applications of FIG. 1, according to various embodiments; and

FIGS. 3A-3B set forth a flow diagram of method steps for streaming a live event, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

Some media service providers stream a live event in real-time to a variety of different client devices via dual streaming pipelines, dual origin servers, and a CDN. A “preferred” streaming pipeline encodes live media feeds across a variety of different encoding parameters to generate preferred versions of segments of different streams. Concurrently, an “alternate” streaming pipeline redundantly encodes the live media feeds across the different encoding parameters to generate alternate versions of the segments. As each version of each segment is generated, each origin server stores a different copy of the version of the segment in an associated region of a memory (e.g., cloud storage) that is accessible to both origin servers. Relative to an origin server, a “local” copy refers to a copy stored in the associated region of memory and a “remote” copy refers to a copy stored in another region of memory.

Throughout a live event, each origin server delivers segments of streams associated with the live event to various client devices, on-demand, via a content delivery network (CDN) of caching servers. When responding to a request for a segment in many conventional implementations, each origin server returns, in descending order of preference, one of:
a local copy of a preferred version of the segment
a remote copy of the preferred version of the segment
a local copy of an alternate version of the segment
a remote copy of the alternate version of the segment
an error message

One drawback of the above approach is that, if a preferred version of a segment exists but includes one or more errors, then the origin server delivers the preferred version of the segment to the CDN even if an alternate version of the same segment exists and is error-free. Because the CDN ends up delivering the preferred version of the segment to client devices, even when that preferred version includes errors, the overall viewing qualities experienced by users of the client devices can be substantially reduced. For example, if the preferred versions of one or more segments exist but include errors, then users of the client devices could unnecessarily experience frame freezes, black frames, audio/video synchronization issues, and/or other playback issues that diminish the overall viewing quality and experience.

With the disclosed techniques, however, each origin server is configured to preferentially deliver error-free versions of segments. More specifically, when responding to a request for a segment, each origin server returns, in descending order of preference, one of:
a local copy of an error-free preferred version of the segment
a remote copy of the error-free preferred version of the segment
a local copy of an error-free alternate version of the segment
a remote copy of the error-free alternate version of the segment
a modified version of the segment
a version of the segment that includes one or more errors
an error message

Each origin server can perform any number and/or types of error check(s) on any copy of a version of a requested segment to determine whether that version of the requested object includes error(s) or is error-free. Each origin server can perform any number and/or types of error concealment operations on any copy of any version of a requested segment that includes error(s) to generate a modified version of the requested segment.

At least one technical advantage of the disclosed techniques relative to the prior art is that, with the disclosed techniques, the quality of segments that are ultimately delivered to client devices when streaming a live event can be increased. In particular, with the disclosed techniques, error-free versions of segments are preferentially delivered to client devices via a CDN. Further, if no error-free version of a segment exists, then error concealment operations can be performed on any version of the segment to mitigate the error(s). Accordingly, implementing the disclosed techniques can substantially improve the overall viewing quality experienced by users of client devices who are watching a live event relative to prior art techniques that preferentially deliver preferred versions of segments irrespective of any errors included in the preferred versions of the segments. These technical advantages provide one or more technological advancements over prior art approaches.

### System Overview

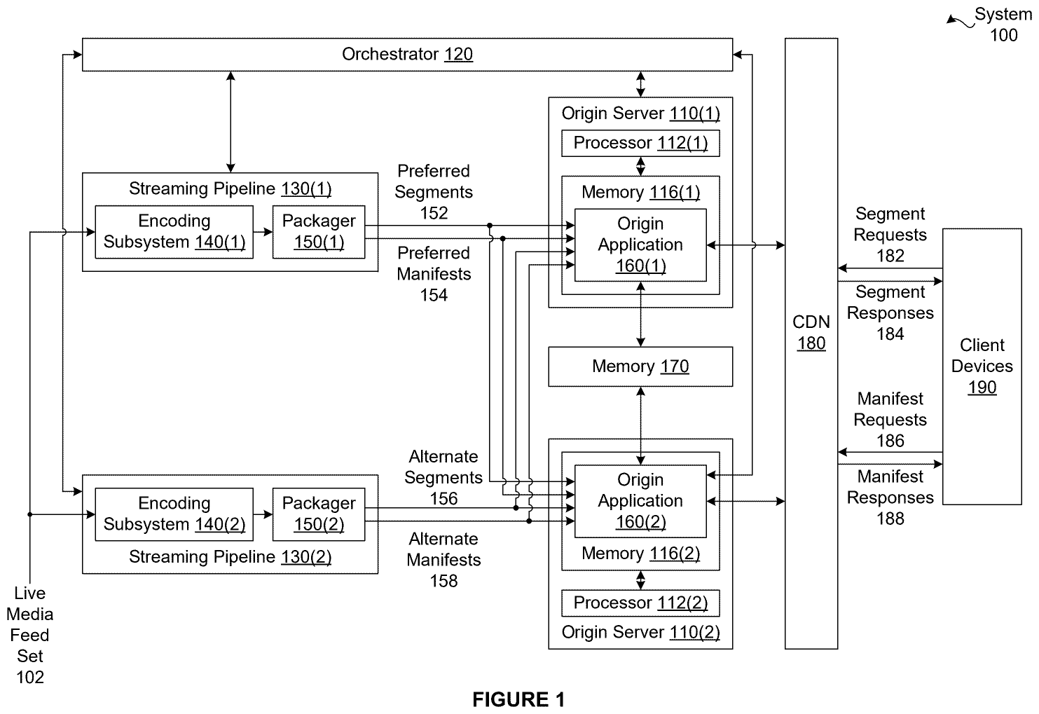

FIG. 1 is a conceptual illustration of a system 100 configured to implement one or more aspects of the various embodiments. As shown, in some embodiments, the system 100 includes, without limitation, a streaming pipeline 130(1), a streaming pipeline 130(2), an origin server 110(1), an origin server 110(2), a memory 170, a content delivery network (CDN) 180, client devices 190, and an orchestrator 120.

In some other embodiments, the system 100 can omit the streaming pipeline 130(2), the origin server 110(2), the CDN 180, the orchestrator 120, or any combination thereof. In the same or other embodiments, the system 100 can further include one or more other streaming pipelines, one or more other origin servers, one or more other memories, one or more other CDNs, or any combination thereof.

Any number of the components of the system 100 can be distributed across multiple geographic locations. Any number of the components of the system 100 can be implemented in one or more cloud computing environments (e.g., encapsulated shared resources, software, data), implemented as part of any other distributed computing environment, implemented in a stand-alone fashion, or any combination thereof.

For explanatory purposes, the functionality of the streaming pipeline 130(1), the streaming pipeline 130(2), the origin server 110(1), the origin server 110(2), the memory 170, the CDN 180, the client devices 190, and the orchestrator 120 are described herein in the context of streaming a live event based on a live media feed set 102. The live media feed set 102 includes, without limitation, one or more live media feeds that each relay media content associated with a different source (e.g., different cameras, different microphones). Some examples of live events are a live sporting event, a live television show, a live performance, a live speech, and a live meeting. Some examples of different types of media content are video, audio, and captions.

As shown, the streaming pipeline 130(1) and the streaming pipeline 130(2) are two different instances of a streaming pipeline that are configured as redundant streaming pipelines and, more specifically, dual streaming pipelines. For explanatory purposes, the streaming pipeline 130(1) and the streaming pipeline 130(2) are also referred to herein individually as a “streaming pipeline 130” and collectively as “streaming pipelines 130.” The streaming pipeline 130(1) is also referred to herein as a “preferred streaming pipeline” and the streaming pipeline 130(2) is also referred to herein as an “alternate streaming pipeline.” In some other embodiments, any number of additional instances of the streaming pipeline can be used to provide additional redundancy, and the techniques described herein are modified accordingly.

Throughout the live event, the streaming pipeline 130(1) and the streaming pipeline 130(2) concurrently and periodically generate different versions of segments of one or more streams associated with the live event based on the live media feed set 102. Also throughout the live event, the streaming pipeline 130(1) and the streaming pipeline 130(2) concurrently and periodically generate different versions of one or more manifests associated with the live event based on the live media feed set 102.

As referred to herein, a “stream” is an encoded version of any type of media data. Each stream that is derived from a live media feed includes, without limitation, a sequence of one or more discrete, time-based segments that correspond (in a playback timeline) to a sequence of one or more discrete portions of the live media feed. For explanatory purposes, a “segment” as used herein refers to a segment of a stream.

Each portion of a live media feed corresponds to a different segment index, where the segment index indicates the position of the portion of the live media feed within the playback timeline relative to the other portions of the live media feed. For instance, in some embodiments, the portion of the live event feed that starts at the beginning of an associated live event corresponds to a segment index of 1, the next portion of the live media feed corresponds to a segment index of 2, etc.

Each segment of each stream derived from a given portion of a given live media feed indicates the segment index of that same portion of that same live media feed. Importantly, segments of different streams derived from the same live media feed that indicate the same segment index correspond to the same time interval in the same playback timeline.

The manifest files enable the client devices 190 to stream the live event via the CDN 180. More precisely, each manifest file describes at least a portion of each of one or more streams that are generated in real-time during the live event, where each portion of each stream corresponds to the same interval in the playback timeline of the live event. In some embodiments, each manifest file indicates the segments of the described portion(s) of stream(s) and provides any number and/or types of playback instructions. The playback instructions can be used by the client devices 190 to determine when and how to request segments from the CDN 180.

In some embodiments, the streaming pipelines 130 concurrently and periodically generate and regenerate two different types of manifests that are referred to herein as “window manifests” and “event manifests” throughout the live event. A window manifest generated or regenerated by the streaming pipeline 130 at a particular point-in-time indicates segments of one or more streams associated with the live event that have been generated by the streaming pipeline 130 within a sliding time window that ends at that point-in-time. By contrast, an event manifest generated or regenerated by the streaming pipeline 130 at a particular point-in-time indicates all segments of one or more streams associated with the live event that have been generated by the streaming pipeline 130 at that point-in-time.

For instance, if the sliding time window has a fixed duration of thirty seconds, then a window manifest generated by the streaming pipeline 130 at a particular point-in-time indicates segments of one or more streams associated with the live event that have been generated by the streaming pipeline 130 within the last thirty seconds. By contrast, an event manifest generated by the streaming pipeline 130 at the same point-in-time indicates all segments of one or more streams associated with the live event that have been generated by the streaming pipeline 130 thus-far.

Notably, if a window manifest generated by the streaming pipeline 130 at a particular point-in-time describes a first portion of a stream associated with the live event, then an event manifest generated by the streaming pipeline 130 at a later point-in-time describes the first portion of the stream and at least a second portion of the stream. And an event manifest generated by the streaming pipeline 130 at or after the end of the live event describes the entire stream. More specifically, an event manifest generated by the streaming pipeline 130 at or after the end of the live event indicates segments of the stream that collectively span the entire playback timeline of the live event.

As shown, throughout the live event, the streaming pipeline 130(1) generates preferred segments 152 and preferred manifests 154 based on the live media feed set 102. The preferred segments 152 are preferred versions of segments of the stream(s) associated with the live event, and the preferred manifests 154 are preferred versions of the manifests associated with the live event. The streaming pipeline 130(1) includes, without limitation, an encoding subsystem 140(1) and a packager 150(1).

As the encoding subsystem 140(1) receives the live media feed set 102, the encoding subsystem 140(1) performs distribution encoding on the live media feed set 102 to generate the preferred segments 152. More specifically, the encoding subsystem 140(1) encodes each live media feed in the live media feed set 102 in real-time across one or more sets of encoding parameters to incrementally generate one or more streams having different characteristics. For instance, in some embodiments, the encoding subsystem 140(1) encodes video content included in a live video feed in the live media feed set 102 across multiple sets of encoding parameters to generate video streams having different combinations of resolutions and bitrates.

The packager 150(1) performs any number and/or types of packaging operations on the preferred segments 152 to prepare the preferred segments 152 for delivery to the client devices 190 via the CDN 180 and generates the preferred manifests 154. Some examples of packaging operations include encrypting segments, applying digital rights management (DRM) to segments, and reformatting segments.

The packager 150(1) can generate the preferred manifests 154 in any technically feasible fashion. In some embodiments, the packager 150(1) periodically (e.g., every five seconds) throughout the live event generates or regenerates, without limitation, a preferred version of a window manifest and a preferred version of an event manifest based on the preferred segments 152.

As shown, the packager 150(1) relays the preferred segments 152 and the preferred manifests 154 to both the origin server 110(1) and the origin server 110(2). In some other embodiments, the packager 150(1) can relay the preferred segments 152 and the preferred manifests 154 to any number of additional origin servers. In yet other embodiments, the packager 150(1) can relay the preferred segments 152 and the preferred manifests 154 to the origin server 110(1), and the origin server 110(2) is omitted from the system. The techniques described herein are modified accordingly.

As shown, throughout the live event, the streaming pipeline 130(2) generates alternate segments 156 and alternate manifests 158 based on the live media feed set 102. The alternate segments 156 are alternate versions of segments of the stream(s) associated with the live event, and the alternate manifests 158 are alternate versions of the manifests associated with the live event. The streaming pipeline 130(2) includes, without limitation, an encoding subsystem 140(2) and a packager 150(2).

As the encoding subsystem 140(2) receives the live media feed set 102, the encoding subsystem 140(2) performs distribution encoding on the live media feed set 102 to generate the alternate segments 156. More specifically, the encoding subsystem 140(2) encodes each live media feed in the live media feed set 102 in real-time across one or more sets of encoding parameters to incrementally generate one or more streams having different characteristics. For instance, in some embodiments, the encoding subsystem 140(2) encodes video content included in a live video feed in the live media feed set 102 across multiple sets of encoding parameters to generate video streams having different combinations of resolutions and bitrates.

The packager 150(2) performs any number and/or types of packaging operations on the alternate segments 156 to prepare the alternate segments 156 for delivery to the client devices 190 via the CDN 180 and generates the alternate manifests 158. The packager 150(2) can generate the alternate manifests 158 in any technically feasible fashion. In some embodiments, the packager 150(2) periodically (e.g., every five seconds) throughout the live event generates or regenerates, without limitation, an alternate version of a window manifest and an alternate version of an event manifest based on the alternate segments 156.

As shown, the packager 150(2) relays the alternate segments 156 and the alternate manifests 158 to both the origin server 110(1) and the origin server 110(2). In some other embodiments, the packager 150(2) can relay the alternate segments 156 and the alternate manifests 158 to any number of additional origin servers. In yet other embodiments, the packager 150(2) can relay the alternate segments 156 and the alternate manifests 158 to the origin server 110(1), and the origin server 110(2) is omitted from the system. The techniques described herein are modified accordingly.

The origin server 110(1) and the origin server 110(2) are different instances of an origin server 110 (not explicitly shown). As shown, the origin server 110(1) includes, without limitation, a processor 112(1) and a memory 116(1), and the origin server 110(2) includes, without limitation, a processor 112(2) and a memory 116(2). In some other embodiments, each of the origin server 110(1) and the origin server 110(2) can include any number of other processors and/or any number of other memories in any combination.

For explanatory purposes, the origin server 110(1) and the origin server 110(2) are also referred to herein individually as the “origin server 110” and collectively as “origin servers 110.” The processor 112(1) and the processor 112(2) are also referred to herein individually as a “processor 112” and collectively as “processors 112.” The memory 116(1) and the memory 116(2) are also referred to herein individually as a “memory 116” and collectively as “the memories 116.”

The processor 112 can be any instruction execution system, apparatus, or device capable of executing instructions. For example, the processor 112 could comprise a central processing unit, a graphics processing unit, a controller, a micro-controller, a state machine, or any combination thereof. The memory 116 of the origin server 110 stores content, such as software applications and data, for use by the processor 112 of the origin server 110.

The memory 116 can be one or more of a readily available memory, such as random-access memory, read only memory, floppy disk, hard disk, or any other form of digital storage, local or remote. In some embodiments, a storage (not shown) may supplement or replace the memory 116. The storage may include any number and type of external memories that are accessible to the processor 112 of the origin server 110. For example, and without limitation, the storage can include a Secure Digital Card, an external Flash memory, a portable compact disc read-only memory, an optical storage device, a magnetic storage device, or any suitable combination of the foregoing.

In some embodiments, each instance of the origin server 110 is a different compute instance. Although not shown, in the same or other embodiments, any number of other compute instances can be configured to implement the streaming pipeline 130(1), the encoding subsystem 140(1), the packager 150(1), the streaming pipeline 130(2), the encoding subsystem 140(2), the packager 150(2), the CDN 180, the client devices 190, the orchestrator 120, or any combination thereof.

In general, each compute instance (including each of the origin servers 110) is configured to implement one or more software applications. For explanatory purposes only, each software application is described as residing in the memory of a single compute instance and executing on a processor of the same compute instance. However, in some embodiments, the functionality of each software application can be distributed across any number of other software applications that reside in the memories of any number of compute instances and execute on the processors of any number of compute instances in any combination. Further, the functionality of any number of software applications can be consolidated into a single software application.

In particular, the origin server 110(1) and the origin server 110(2) are configured to store in the memory 170 copies of received segments and manifests for on-demand delivery to any number of the client devices 190 via the CDN 180. The received segments and the received manifests include, without limitation, the preferred segments 152, the preferred manifests 154, the alternate segments 156, and the alternate manifests 158.

The memory 170 can include any number and/or types of memory that are accessible to both the origin server 110(1) and the origin server 110(2). In some embodiments, the memory 170 is cloud storage. In the same or other embodiments, each origin server 110 is configured to store copies of received segments and received manifests in a different region of the memory 170 that is considered a “local region” with respect to that origin server 110 and is considered a “remote region” with respect to the other origin server 110. In some embodiments, each origin server 110 can write to and read from the local region of the memory 170 and can read from the remote region of the memory 170, but cannot write to the remote region of the memory 170.

The CDN 180 delivers segments and manifests on behalf of the origin servers 110 to any number of the client devices 190 on-demand. The CDN 180 includes, without limitation, any number of and/or types of caching servers (not shown) that are each capable of selectively caching segments of streams and manifests.

Each of the client devices 190 can be any type of device that is capable of communicating with the CDN 180 to stream live events. More specifically, each of the client devices 190 is capable of requesting, decoding, and playing back segments of streams associated with a live event based on manifests associated with the live event.

As shown, to stream the live event in real-time, any number of the client devices 190 transmit segment requests 182 and manifest requests 186 to the CDN 180 and, in response, receive segment responses 184 and manifest responses 188 from the CDN 180. Each of the segment requests 182 is a request for a segment of a stream associated with the live event. Each of the manifest requests 186 is a request for a manifest associated with the live event. Each of the segment responses 184 is a response that either includes a requested segment or indicates an error (e.g., indicating that the requested segment was not found). Each of the manifest responses 188 is a response that either includes a requested manifest or indicates an error (e.g., indicating that the requested manifest was not found).

In general, for each request transmitted from a client device to the CDN 180, if the CDN 180 has the requested object (e.g., a segment, a manifest) stored in an associated cache memory, then a “cache hit” occurs, and the CDN 180 transmits a corresponding response that includes the requested object to the client device. Otherwise, a “cache miss” occurs, and the CDN 180 relays the request to one of the origin servers 110.

For each request relayed from the CDN 180 to the origin server 110, if the origin server 110 is able to successfully retrieve any version of the requested object from the memory 170, then the origin server 110 transmits a corresponding response that includes the requested object to the CDN 180. Otherwise, the origin server 110 transmits a corresponding response indicating an error (e.g., indicating that the requested object was not found) to the CDN 180. Irrespective of whether the origin server 110 was able to successfully retrieve the requested object, the CDN 180 relays the corresponding response received from the origin server 110 to the client device that originally generated the request.

As described previously herein, in one conventional approach to streaming live events using dual streaming pipelines, an origin server preferentially delivers preferred versions of segments to a CDN irrespective of any errors included in the preferred versions of the segments. In a similar fashion, the origin server preferentially delivers preferred versions of manifests to the CDN irrespective of any errors included in the preferred versions of the manifests.

One drawback of the above approach is that, if a preferred version of a requested segment or a requested manifest exists but includes one or more errors, then the origin server delivers the preferred version of the segment or the manifest to the CDN even if an alternate version of the same segment or manifest exists and is error-free. Because the CDN ends up delivering the preferred version of the segment or manifest to client devices, even when that preferred version includes errors, the overall viewing qualities experienced by users of the client devices can be substantially reduced.

### Implementing Quality Criteria When Selecting Segments and Manifests for Delivery to a CDN

To address the above problems, in some embodiments, the system 100 includes an origin application 160(1) and an origin application 160(2). The origin application 160(1) and the origin application 160(2) are different instances of an origin application 160 (not explicitly shown) that implements quality criteria when selecting between versions of segments and versions of manifests for delivery to a CDN. In some embodiments, the origin application 160 performs error checks on segments and manifests. In the same or other embodiments, the origin application 160 performs any number and/or types of error concealment operations and/or any number and/or types of repair operations on segments and/or manifests that include one or more errors.

As shown, in some embodiments, the system 100 includes an orchestrator 120 that facilitates error checking operations, error concealment operations, repair operations, error reporting operations, or any combination thereof associated with streaming the live event and optionally any number of other live events. In particular, the orchestrator 120 determines a publishing configuration (not shown in FIG. 1) for the live event and transmits the publishing configuration to the streaming pipeline 130(1), the streaming pipeline 130(2), the origin application 160(1), and the origin application 160(2) prior to the start of the live event.

The orchestrator 120 can determine the publishing configuration in any technically feasible fashion. For instance, in some embodiments, the orchestrator 120 interacts with one or more users via a graphical user interface (GUI) or any other type of user interface to determine the publishing configuration. In the same or other embodiments, the orchestrator 120 can interact with any number and/or types of software applications to determine the publishing configuration.

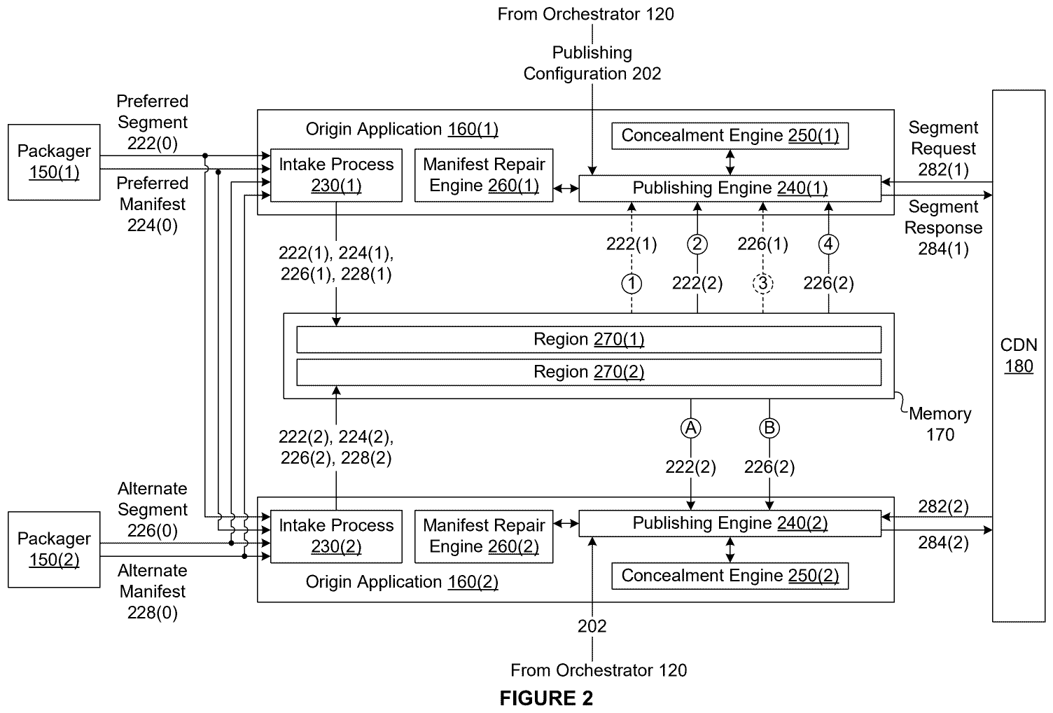

In some embodiments, the publishing configuration includes metadata specifying timing of the live event, one or more properties of segments of streams associated with the live event, and optionally any amount and/or types of other metadata that is relevant to streaming the live event. Notably, the publishing configuration enables the origin application 160(1) and the origin application 160(2) to detect various errors (e.g., timing discontinuities, late arrival times, incorrect duration) in segments and manifests associated with the live event. As described in greater detail below in conjunction with FIG. 2, in some embodiments, the publishing configuration specifies, without limitation, a segment duration. In the same or other embodiments, the origin application 160(1) and the origin application 160(2) detect a start time for the live event and determine an initial segment index when the streaming of the live event starts.

For explanatory purposes, the quality-based strategies and associated functionalities implemented by the origin application 160 are depicted in and described in conjunction with FIGS. 1 and 2 in the context of streaming the live event via two streaming pipelines, two origin servers, and one CDN based, at least in part, on the publishing configuration associated with the live event. Please note, however, that many modifications and variations on the quality-based strategies and associated functionalities implemented by the origin application 160 as described herein will be apparent to those of ordinary skill in the art without departing from the scope and spirit of the described embodiments.

As shown, the origin application 160(1) resides in the memory 116(1) of the origin server 110(1) and executes on the processor 112(1) of the origin server 110(1). The origin application 160(2) resides in the memory 116(2) of the origin server 110(2) and executes on the processor 112(2) of the origin server 110(2). For explanatory purposes, the origin application 160(1) and the origin application 160(2) are also referred to herein individually as an “origin application 160” and collectively as “origin applications 160.”

Throughout the live event, the origin application 160(1) receives and stores in a first region (not shown if FIG. 1) of the memory 170 the preferred segments 152, the preferred manifests 154, the alternate segments 156, and the alternate manifests 158. Concurrently, the origin application 160(2) receives and stores in a second region (not shown in FIG. 1) of the memory 170 the preferred segments 152, the preferred manifests 154, the alternate segments 156, and the alternate manifests 158. Accordingly, when the system 100 is operating as expected, two different copies of each of the preferred segments 152, the preferred manifests 154, the alternate segments 156, and the alternate manifests 158 are stored in the memory 170.

With respect to the origin application 160(1), the first region of the memory 170 is considered a local region of the memory 170 and the second region of the memory 170 is considered a remote region of the memory 170. With respect to the origin application 160(2), the first region of the memory 170 is considered a remote region of the memory 170 and the second region of the memory 170 is considered a local region of the memory 170.

Throughout the live event, each of the origin applications 160 deliver, on-demand, segments and manifests associated the live events to any number of the client devices 190 via the CDN 180. For explanatory purposes, the segment requests 182 and the manifest requests 186 are also referred to herein individually as a “request” and collectively as “requests.” The corresponding “requested” segments and “requested” manifests are also referred to herein individually as a “requested object.” The segment responses 184 and the manifest responses 188 are also referred to herein individually as a “response” and collectively as “responses.”

Upon receiving a request associated with the live event from the CDN 180, the origin application 160 attempts to retrieve from the local region of the memory 170 a preferred version of the requested object (one of the preferred segments 152 or the preferred manifests 154). If the origin application 160 fails to retrieve the preferred version of the requested object from the local region of the memory 170, then the origin application 160 attempts to retrieve from the remote region of the memory 170 the preferred version of the requested object.

If the origin application 160 is able to retrieve the preferred version of the requested object from either region of the memory 170, then the origin application 160 performs one or more error checks on the preferred version of the requested object based on the publishing configuration to determine whether the preferred version of the requested object includes one or more errors.

The origin application 160 can perform any number and/or types of error checks on any version of a requested object in any technically feasible fashion. In general, if any of the error checks that the origin application 160 performs on a version of a requested object detect any errors, then the origin application 160 determines that the version of the requested object includes one or more errors. Otherwise, the origin application 160 determines that the version of the requested object does not include any errors and designates the version of the requested object as “error-free.”

As described in greater detail below in conjunction with FIG. 2, in some embodiments, the origin application 160 performs error checks on a version of a requested segment to detect whether the version of the requested segment has any timing discontinuities or an incorrect number of frames. If the origin application 160 determines that the version of the requested segment has at least one of a timing discontinuity or an incorrect number of frames, then the origin application 160 determines that the version of the requested segment includes one or more errors.

In the same or other embodiments, the origin application 160 performs error checks on a requested manifest to detect whether the requested manifest fails to indicate one or more segments that are expected to be included in the portion(s) of stream(s) described in the requested manifest. If the origin application 160 determines that the requested manifest fails to indicate one or more of the expected segments, then the origin application 160 determines that the requested manifest includes one or more errors.

If the origin application 160 determines that the preferred version of the requested object does not include any errors, then the origin application 160 generates and transmits to the CDN 180 a response that includes the preferred version of the requested object. As a result, if the preferred version of the requested object exists and does not include any errors, then the preferred version of the requested object is delivered to one or more of the client devices 190 via the CDN 180.

If, however, the origin application 160 fails to retrieve the preferred version of the requested object from both regions of the memory 170 or determines that the preferred version of the requested object includes one or more errors, then the origin application 160 attempts to retrieve from the local region of the memory 170 the alternate version of the requested object. If the origin application 160 fails to retrieve the alternate version of the requested object from the local region of the memory 170, then the origin application 160 attempts to retrieve from the remote region of the memory 170 the alternate version of the requested object.

If the origin application 160 is able to retrieve the alternate version of the requested object from either region of the memory 170, then the origin application 160 performs one or more error checks on the alternate version of the requested object based on the publishing configuration to determine whether the alternate version of the requested object includes one or more errors.

If the origin application 160 determines that the alternate version of the requested object does not include any errors, then the origin application 160 generates and transmits to the CDN 180 a response that includes the alternate version of the requested object. As a result, if the preferred version of the requested object does not exist or exists and includes one or more errors and the alternate version of the requested object exists and is error-free, then the alternate version of the requested object is delivered to one or more of the client devices 190 via the CDN 180.

If the origin application 160 fails to retrieve any version of the requested object from any region of the memory 170, then the origin application 160 generates and transmits to the CDN 180 a response indicating that the requested object was not found.

If, however, each retrieved version of the requested object includes one or more errors, then the origin application selects one of the retrieved version(s) of the requested object. More specifically, if the origin application 160 was able to retrieve the preferred version of the requested object, then the origin application 160 selects the preferred version of the requested object. Otherwise, the origin application 160 selects the alternate version of the requested object.

If the requested object is a segment, then the origin application 160 performs zero or more error concealment operations on the selected version of the requested segment to generate an optionally modified version of the requested segment. The origin application 160 generates and transmits to the CDN 180 a response that includes that optionally modified version of the requested segment. The origin application 160 can implement any number and/or types of error concealment operations in any technically feasible fashion.

For instance, in some embodiments, if the requested object is a segment of a video stream, then the origin application 160 could insert one or more replicated frames and/or one or more black frames into the selected version of the requested segment. In the same or other embodiments, if the requested object is a segment of an audio stream, then the origin application 160 could insert one or more portions of silent audio into the selected version of the requested segment.

If the requested object is a manifest, then the origin application 160 performs zero or more repair operations on the selected version of the requested manifest to generate an optionally repaired version of the requested manifest. The origin application 160 generates and transmits to the CDN 180 a response that includes that optionally repaired version of the requested manifest. The origin application 160 can implement any number and/or types of repair operations in any technically feasible fashion.

For instance, in some embodiments, the origin application 160 can generate or regenerate any portion (including all) of the selected version of the requested manifest based on the publishing configuration, any number of manifests stored in the memory 170, any number of segments stored in the memory 170, or any combination thereof.

Advantageously, with the disclosed techniques, error-free versions of segments and manifests are preferentially delivered to client devices via a CDN when streaming a live event. Another advantage of the disclosed techniques is that if no error-free version of a segment or manifest exists, then error concealment operations and/or repair operations can be performed on a version of the segment or manifest that includes error(s) to mitigate the error(s). As a result, with the disclosed techniques, the overall viewing quality experienced by users of client devices who are watching the live event can be substantially improved relative to prior art techniques that preferentially deliver preferred versions of segments irrespective of any errors included in the preferred versions of the segments.

Please note that the techniques described herein are illustrative rather than restrictive and can be altered without departing from the broader spirit and scope of the embodiments. Many modifications and variations on the functionality of the origin application 160, the orchestrator 120, the streaming pipeline 130, the CDN 180, and the client devices 190 as described herein will be apparent to those of ordinary skill in the art without departing from the scope and spirit of the described embodiments.

In particular, in some embodiments, each of one or more instances of the origin application 160 can independently store in a different region of a memory a different copy of multiple versions of segments and/or manifests associated with any number of live events, where each version is received from a different streaming pipeline. In the same or other embodiments, each of one or more instances of the origin application 160 can select between one or more copies of multiple versions of segments and/or manifests based, at least in part, on any number and/or types of quality criteria.

In some embodiments, two or more streaming pipelines can be ranked in preference order in any technically feasible fashion, and the origin application 160 preferentially delivers an error-free version of a requested object that is generated by a higher ranked streaming pipeline. In the same or other embodiments, two or more streaming pipelines can be re-ranked on-the-fly based on any amount and/or types of data.

For instance, in some embodiments, the orchestrator 120 initially ranks the streaming pipeline 130(1) and the streaming pipeline 130(2) such that the streaming pipeline 130(1) is a preferred streaming pipeline and the streaming pipeline 130(2) is an alternate streaming pipeline. If the origin application 160 detects that a version of a segment generated by the streaming pipeline 130(1) includes one or more errors or that the streaming pipeline 130(1) is delivering segments later than expected, then the origin application 160 generates and transmits to the orchestrator 120 an error message indicating that the streaming pipeline 130(1) is compromised. In response, the orchestrator 120 can swap the preference rankings for the streaming pipeline 130(1) and the streaming pipeline 130(2), display a warning message via a GUI, update error statistics, or any combination thereof.

In some embodiments, each instance of the origin application 160 independently ranks two or more memories or regions of memories in preference order in any technically feasible fashion (e.g., from local to most remote). Each instance of the origin application 160 preferentially attempts to retrieve a copy of a particular version of a requested object from the highest ranked memory or highest ranked region of memory.

It will be apparent to one skilled in the art that the inventive concepts may be practiced without one or more of these specific details. For instance, in some alternate embodiments, the origin application 160 does not receive event manifests and/or window manifests from any streaming pipeline and/or does not perform error checks on event manifests and/or window manifests. In the same or other embodiments, the origin application 160 can generate any number of event manifests and/or window manifests based on any versions of event manifests, window manifests, segments, or any combination thereof that are received from any number of streaming pipelines.

For instance, in some embodiments, the origin application 160 receives a preferred version and an alternate version of a first window manifest for a live event, where the first window manifest is associated with a first period of time. Subsequently, the origin application 160 receives a preferred version and an alternate version of a second window manifest for the live event, where the second window manifest is associated with a second period of time. The origin application 160 determines that the preferred version of the first window manifest includes one or more errors, the alternate version of the first window manifest is error-free, and the preferred version of the second window manifest is error-free. The origin application 160 generates an event manifest associated with the live event based on the alternate version of the first window manifest and the preferred version of the second window manifest.

In some embodiments, the streaming pipelines 130 perform any amount and/or types of error checking on segments and/or manifests and indicates whether any errors are included in each of the preferred segments 152, the preferred manifests 154, the alternate segments 156, and the alternate manifests 158 in any technically feasible fashion (e.g., via headers). In the same or other embodiments, the origin application 160 determines whether each of the preferred segments 152, the preferred manifests 154, the alternate segments 156, and the alternate manifests 158 is error-free based on errors identified by the streaming pipelines 130 in any technically feasible fashion.

In some alternate embodiments, if the origin application 160 is unable to retrieve any version of a requested segment or a requested manifest, then the origin application 160 can optionally generate a new version of the requested segment or the requested manifest in any technically feasible fashion. For instance, if the origin application 160 is unable to retrieve any version of a requested audio segment, then the origin application 160 generates a new version of the requested audio segment that includes silent audio. If the origin application 160 is unable to retrieve any version of a requested video segment, then the origin application 160 generates a new version of the requested video segment that includes black frames. The origin application 160 then generates and transmits to the CDN 180 a segment response that includes the new version of the requested segment.

Similarly, the storage, organization, amount, and/or types of data described herein are illustrative rather than restrictive and can be altered without departing from the broader spirit and scope of the embodiments. In that regard, many modifications and variations on the publishing configuration, the preferred segments 152, the preferred manifests 154, the alternate segments 156, the alternate manifests 158, the segment requests 182, the segment responses 184, the manifest requests 186, and the manifest responses 188 as described herein will be apparent to those of ordinary skill in the art without departing from the scope and spirit of the described embodiments.

For instance, in some embodiments, the origin application 160 can perform any number and/or types of error checks on segments and/or manifests based on any amounts and/or types of data acquired in any technically feasible fashion instead of or in addition to the publishing configuration. In the same or other embodiments, the orchestrator 120 is omitted from the system 100. In some embodiments, any number of software applications (e.g., the packager 150(1), the packager 150(2), the origin application 160(1), the origin application 160(2)) can generate any number and/or types of manifests in any technically feasible fashion. In the same or other embodiments, each of one or more manifests provide a template indicating an initial segment index, a segment duration and a streaming availability wall clock time.

It will be appreciated that the system 100 shown herein is illustrative and that variations and modifications are possible. For example, the functionality provided by the origin application 160(1), the origin application 160(2), the orchestrator 120, the streaming pipeline 130(1), the streaming pipeline 130(2), the encoding subsystem 140(1), the encoding subsystem 140(2), the packager 150(1), the packager 150(2), the CDN 180, and the client devices 190 as described herein can be integrated into or distributed across any number of software applications (including one), and any number of components of the system 100. Further, the connection topology between the various units in FIG. 1 can be modified as desired.

### Preferentially Delivering Error-Free Versions of Segments and Manifests

FIG. 2 is a more detailed illustration of the origin applications 160 of FIG. 1, according to various embodiments. As described previously herein in conjunction with FIG. 1, in some embodiments, the origin application 160 preferentially delivers, on-demand, error-free versions of segments and manifests associated with any number of live events to client devices 190 via the CDN 180. If the origin application 160 determines that no error-free version of a requested segment or a requested manifest exists, then the origin application 160 can optionally perform any number and/or types of error concealment operations and/or repair operations on a version of the requested segment or requested manifest that includes one or more errors.

As shown, the origin application 160(1) includes, without limitation, an intake process 230(1), a publishing engine 240(1), a concealment engine 250(1), and a manifest repair engine 260(1). The origin application 160(2) includes, without limitation, an intake process 230(2), a publishing engine 240(2), a concealment engine 250(2), and a manifest repair engine 260(2).

For explanatory purposes, the intake process 230(1) and the intake process 230(2) are also referred to herein individually as an “intake process 230” and collectively as “intake processes 230.” The publishing engine 240(1) and the publishing engine 240(2) are also referred to herein individually as a “publishing engine 240” and collectively as “publishing engines 240.” The concealment engine 250(1) and the concealment engine 250(2) are also referred to herein individually as a “concealment engine 250” and collectively as “concealment engines 250.” The manifest repair engine 260(1) and the manifest repair engine 260(2) are also referred to herein individually as a “manifest repair engine 260” and collectively as “manifest repair engines 260.”

Each of the origin application 160(1) and the origin application 160(2) can access a memory 170. As shown, the memory 170 includes, without limitation, a region 270(1) and a region 270(2). With respect to the origin application 160(1), the region 270(1) is considered a local region of the memory 170, and the region 270(2) is considered a remote region of the memory 170. With respect to the origin application 160(2), the region 270(1) is considered a remote region of the memory 170, and the region 270(2) is considered a local region of the memory 170. For explanatory purposes, a copy of an object that the origin application 160 retrieves from a local region of the memory 170 is also referred to herein as a “local copy.” And a copy of an object that the origin application 160 retrieves from a remote region of the memory 170 is also referred to herein as a “remote copy.”

As described previously herein in conjunction with FIG. 1, prior to a live event, the origin application 160(1) and the origin application 160(2) receive from the orchestrator 120 a publishing configuration 202 for the live event. The publishing configuration 202 includes, without limitation, metadata specifying timing of the live event, one or more properties of segments of streams associated with the live event, and optionally any amount and/or types of other metadata that is relevant to streaming the live event. For instance, in some embodiments, the publishing configuration 202 specifies, without limitation, a segment duration.

As shown, at the start of the live event, the origin application 160(1) launches the intake process 230(1), and the origin application 160(2) launches the intake process 230(2). Referring back now to FIG. 1, throughout the live event, the intake processes 230 concurrently receive and store in the memory 170 the preferred segments 152, the preferred manifests 154, the alternate segments 156, and the alternate manifests 158.

More precisely, as the intake process 230(1) receives an object (e.g., one of the preferred segments 152, the preferred manifests 154, the alternate segments 156, or the alternate manifests 158), the intake process 230(1) stores a copy of the object in a region 270(1) of the memory 170. In a complementary fashion, as the intake process 230(2) receives an object (e.g., one of the preferred segments 152, the preferred manifests 154, the alternate segments 156, or the alternate manifests 158), the intake process 230(2) stores a copy of the object in a region 270(2) of the memory 170.

Although not shown, when the streaming of the live event starts, the origin application 160(1) and the origin application 160(2) detect a start time for the live event and determine an initial segment index. Throughout the live event, the CDN 180 relays any number of the segment requests 182 and any number of the manifest requests 186 to the origin application 160(1) and any number of the segment requests 182 and any number of the manifest requests 186 to the origin application 160(2).

As described previously herein, when the origin application 160 receives a request for an object (a segment or a manifest) the publishing engine 240 attempts to retrieve from the memory 170 one of, in descending order of preference, an error-free local copy of a preferred version of the requested object, an error-free remote copy of a preferred version of the requested object, an error-free local copy of an alternate version of the requested object, or an error-free remote copy of the alternate version of the requested object. The publishing engine 240 can perform any number and/or types of error checks on any copy of any version of a requested object in any technically feasible fashion to determine whether the copy of the version of the requested object includes error(s) or is error-free.

For instance, in some embodiments, the publishing engine 240 compares a total number of frames included in a requested segment to an expected number of frames per segment. If the publishing engine 240 determines that the total number of frames included in the requested segment is less than the expected number of frames per segment, then the publishing engine 240 determines that the requested segment includes an incorrect number of frames and therefore includes at least one error. The publishing engine 240 can determine the expected number of frames per segment in any technically feasible fashion. For instance, in some embodiments, the publishing engine 240 computes the expected number of frames per segment based on the segment duration specified in the publishing configuration 202.

In the same or other embodiments, the publishing engine 240 compares a start time associated with a requested segment to an expected start time for the requested segment. If the publishing engine 240 determines that the start time associated with the requested segment does not match the expected start time for the requested segment, then the publishing engine 240 determines that the requested segment includes at least one timing inconsistency and therefore includes at least one error. The publishing engine 240 can determine the expected start time for the requested segment in any technically feasible fashion. For instance, in some embodiments the publishing engine 240 computes the expected start time for the requested segment based on a segment index associated with the requested segment and (as per the publishing configuration 202) the start time for the live event, the segment duration, and the initial segment index.

In some embodiments, the publishing engine 240 performs error checks on a requested manifest to detect whether the requested manifest fails to indicate one or more segments that are expected to be included in the portion(s) of stream(s) described in the requested manifest. If the publishing engine 240 determines that the requested manifest fails to indicate one or more of the expected segments, then the publishing engine 240 determines that the requested manifest includes one or more errors.

If the publishing engine 240 is able to retrieve from the memory 170 an error-free version of the requested object, then the publishing engine 240 generates and transmits to the CDN 180 a response that includes the error-free version of the requested object. If, however, the publishing engine 240 is unable to retrieve from the memory 170 any copy of any version of the requested object, then the publishing engine 240 generates and transmits to the CDN 180 a response indicating that the requested object was not found.

If the publishing engine 240 determines that each retrieved version of a requested object includes one or more errors, then the publishing engine 240 selects for further processing one of, in descending order of preference, a local copy of the preferred version of the requested object, a remote copy of the preferred version of the requested object, a local copy of the alternate version of the requested object, or a remote copy of the alternate version of the requested object.

If the requested object is a segment, then the concealment engine 250 performs zero or more error concealment operations on the selected version of the requested segment to generate an optionally modified version of the requested segment. The publishing engine 240 then generates and transmits to the CDN 180 a segment response that includes the optionally modified version of the requested segment. The concealment engine 250 can implement any number and/or types of error concealment operations in any technically feasible fashion.

For instance, in some embodiments, if the requested object is a segment of a video stream, then the concealment engine 250 could insert one or more replicated frames and/or one or more black frames into the selected version of the requested segment. In the same or other embodiments, if the requested object is a segment of an audio stream, then the concealment engine 250 could insert one or more portions of silent audio into the selected version of the requested segment.

If the requested object is a manifest, then the manifest repair engine 260 performs zero or more repair operations on the selected version of the requested manifest to generate an optionally repaired version of the requested manifest. The publishing engine 240 then generates and transmits to the CDN 180 a manifest response that includes the optionally repaired version of the requested manifest.

The manifest repair engine 260 can implement any number and/or types of repair operations in any technically feasible fashion. For instance, in some embodiments, the manifest repair engine 260 can generate or regenerate any portion (including all) of the selected version of the requested manifest based on the publishing configuration 202, any number of manifests stored in the memory 170, any number of segments stored in the memory 170, or any combination thereof.

For explanatory purposes, FIG. 2 depicts some operations performed by the origin application 160(1) and the origin application 160(2) in conjunction with streaming a single live event during an exemplary period of time. During the exemplary period of time, the intake processes 230 receive from the packager 150(1) a preferred segment 222(0) and a preferred manifest 224(0). Concurrently, the intake processes 230 receive from the packager 150(2) an alternate segment 226(0) and an alternate manifest 228(0). For explanatory purposes, the preferred segment 222(0) and the alternate segment 226(0) are a preferred version and an alternate version, respectively, of an initial segment of a first stream associated with the live event.

As shown, the intake process 230(1) stores in the region 270(1) first copies of the preferred segment 222(0), the preferred manifest 224(0), the alternate segment 226(0), and the alternate manifest 228(0). For explanatory purposes, the first copies of the preferred segment 222(0), the preferred manifest 224(0), the alternate segment 226(0), and the alternate manifest 228(0) are depicted in FIG. 2 and referred to herein as a preferred segment 222(1), a preferred manifest 224(1), an alternate segment 226(1), and an alternate manifest 228(1), respectively.

As shown, the intake process 230(2) stores in the region 270(2) second copies of the preferred segment 222(0), the preferred manifest 224(0), the alternate segment 226(0), and the alternate manifest 228(0). For explanatory purposes, the second copies of the preferred segment 222(0), the preferred manifest 224(0), the alternate segment 226(0), and the alternate manifest 228(0) are depicted in FIG. 2 and referred to herein as a preferred segment 222(2), a preferred manifest 224(2), an alternate segment 226(2), and an alternate manifest 228(2), respectively.

As shown, during the exemplary period of time, the origin application 160(1) receives from the CDN 180 a segment request 282(1) for the initial segment of the first stream associated with the live event, and the origin application 160(2) receives from the CDN 180 a segment request 282(2) for the initial segment of the first stream associated with the live event.

For explanatory purposes, during the exemplary period of time, the region 270(1) of the memory 170 is inaccessible, the preferred version of the initial segment of the first stream (the preferred segment 222(0)) includes one or more errors, and the alternate version of the initial segment of the first stream (the alternate segment 226(0)) is error-free.

A sequence of arrows labeled 1-4 depicts retrieval operations that the publishing engine 240(1) sequentially attempts to perform on the memory 170 in an effort to identify a copy of an error-free version of the initial segment of the first stream. As depicted with a dashed arrow labeled 1, the publishing engine 240(1) fails to retrieve from the region 270(1) the preferred segment 222(1). As depicted with a solid arrow labeled 2, the publishing engine 240(1) successfully retrieves from the region 270(2) the preferred segment 222(2). The publishing engine 240(1) determines that the preferred segment 222(2) includes one or more errors.

As depicted with a dashed arrow labeled 3, the publishing engine 240(1) fails to retrieve from the region 270(1) the alternate segment 226(1). As depicted with a solid arrow labeled 4, the publishing engine 240(1) successfully retrieves from the region 270(2) the alternate segment 226(2). The publishing engine 240(1) determines that the alternate segment 226(2) is error-free. As shown, the publishing engine 240(1) generates and transmits to the CDN 180 a segment response 284(1) that includes the alternate segment 226(2).

A sequence of arrows labeled A-B depicts some retrieval operations that the publishing engine 240(2) sequentially performs on the memory 170 in an effort to identify a copy of an error-free version of the initial segment of the first stream. As depicted with a solid arrow labeled A, the publishing engine 240(2) retrieves from the region 270(2) the preferred segment 222(2). The publishing engine 240(2) determines that the preferred segment 222(2) includes one or more errors.

As depicted with a solid arrow labeled B, the publishing engine 240(2) successfully retrieves from the region 270(2) the alternate segment 226(2). The publishing engine 240(2) determines that the alternate segment 226(2) is error-free. As shown, the publishing engine 240(2) generates and transmits to the CDN 180 a segment response 284(2) that includes the alternate segment 226(2).

Advantageously, as illustrated above, the origin application 160 preferentially delivers error-free versions of segments and manifests. As a result, with the disclosed techniques, the number of segments and manifests having errors that are ultimately delivered to client devices can be reduced relative to prior art techniques that preferentially deliver preferred versions of segments and manifests irrespective of any errors included in the preferred versions of the segments and manifests.

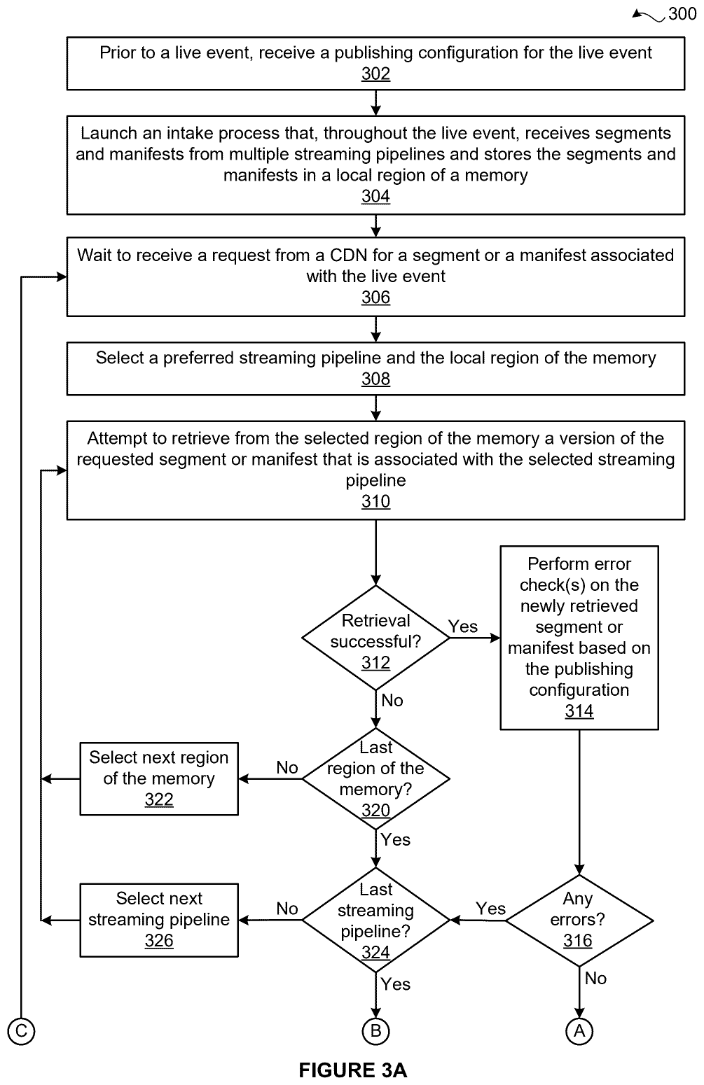

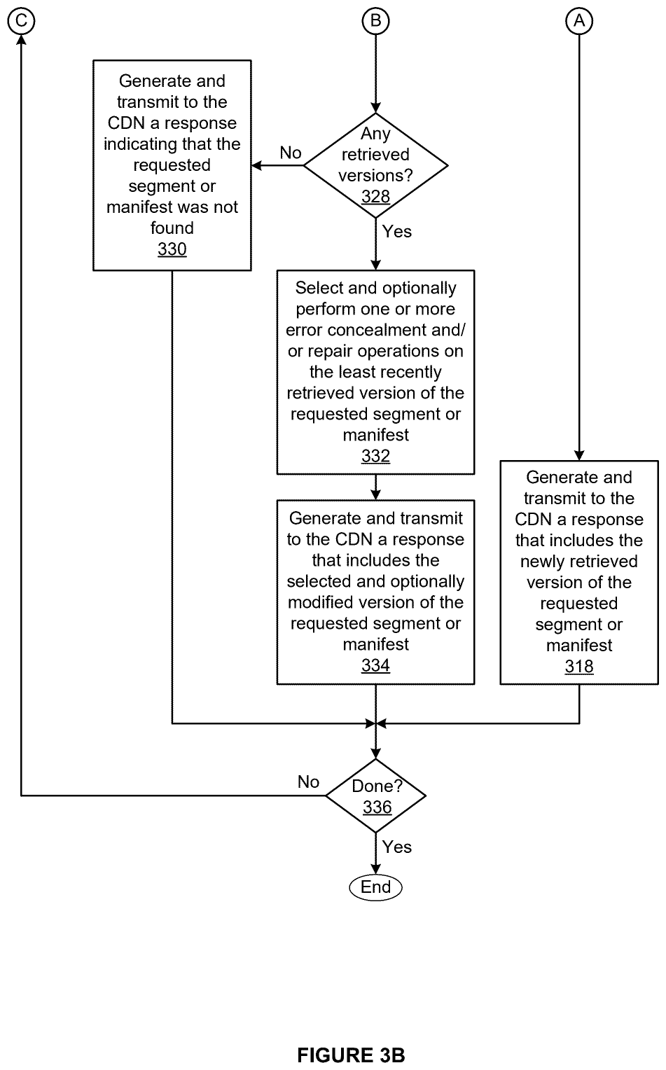

FIGS. 3A-3B set forth a flow diagram of method steps for streaming a live event, according to various embodiments. Although the method steps are described with reference to the systems of FIGS. 1-2, persons skilled in the art will understand that any system configured to implement the method steps, in any order, falls within the scope of the embodiments.

As shown, a method 300 begins at step 302, where, prior to a live event, the origin application 160 receives a publishing configuration for the live event. At step 304, the origin application 160 launches an intake process that, throughout the live event, receives segments and manifests from multiple streaming pipelines and stores the segments and manifests in a local region of a memory.

At step 306, the origin application 160 waits to receive a request from CDN 180 for a segment or a manifest associated with the live event. At step 308, the origin application 160 selects a preferred streaming pipeline and the local region of the memory. At step 310, the origin application 160 attempts to retrieve from the selected region of the memory a version of the requested segment or manifest that is associated with the selected streaming pipeline.

At step 312, the origin application 160 determines whether the retrieval was successful. If, at step 312, the origin application 160 determines that the retrieval was successful, then the method 300 proceeds to step 314. At step 314, the origin application 160 performs error check(s) on the newly retrieved segment or manifest based on the publishing configuration. At step 316, the origin application 160 determines whether the newly retrieved segment or manifest includes any errors. If, at step 316, the origin application 160 determines that the newly retrieved segment or manifest includes one or more errors, then the method 300 proceeds directly to step 324.

If, however, at step 316, the origin application 160 determines that the newly retrieved segment or manifest does not include any errors, then the method 300 proceeds to step 318. At step 318, the origin application 160 generates and transmits to the CDN 180 a response that includes the newly retrieved version of the requested segment or manifest. The method 300 then proceeds directly to step 336.

Returning now to step 312, if the origin application 160 determines that the retrieval was not successful, then the method 300 proceeds directly to step 320. At step 320, the origin application 160 determines whether the selected region of the memory is the last region of the memory. If, at step 320, the origin application 160 determines that the selected region of the memory is the last region of the memory, then the method 300 proceeds directly to step 324.

If, however, at step 320, the origin application 160 determines that the selected region of the memory is not the last region of the memory, then the method 300 proceeds to step 322. At step 322, the origin application 160 selects the next region of the memory. The method 300 then returns to step 310, where the origin application 160 attempts to retrieve from the selected region of the memory a version of the requested segment or manifest that is associated with the selected streaming pipeline.

At step 324, the origin application 160 determines whether the selected streaming pipeline is the last streaming pipeline. If, at step 324, the origin application 160 determines that the selected streaming pipeline is not the last streaming pipeline, then the method 300 proceeds to step 326. At step 326, the origin application 160 selects the next streaming pipeline. The method 300 then returns to step 310, where the origin application 160 attempts to retrieve from the selected region of the memory a version of the requested segment or manifest that is associated with the selected streaming pipeline.

If, however, at step 324, the origin application 160 determines that the selected streaming pipeline is the last streaming pipeline, then the method 300 proceeds directly to step 328. At step 328, the origin application 160 determines whether there are any retrieved versions of the requested segment or manifest. If, at step 328, the origin application 160 determines that there are no retrieved versions of the requested segment or manifest, then the method 300 proceeds to step 330. At step 330, the origin application 160 generates and transmits to the CDN 180 a response indicating that the requested segment or manifest was not found. The method 300 then proceeds directly to step 336.

If, however, at step 328, the origin application 160 determines that there are one or more retrieved versions of the requested segment or manifest, then the method 300 proceeds directly to step 332. At step 332, the origin application 160 selects and optionally performs one or more error concealment and/or repair operations on the least recently retrieved version of the requested segment or manifest. At step 334, the origin application 160 generates and transmits to the CDN 180 a response that includes the selected and optionally modified version of the requested segment or manifest.

At step 336, the origin application 160 determines whether the streaming of the live event is done. If, at step 336, the origin application 160 determines that the streaming of the live event is not done, then the method 300 returns to step 306, where the origin application 160 waits to receive a request from CDN 180 for a segment or a manifest associated with the live event.

If, however, at step 336, the origin application 160 determines that the streaming of the live event is done, then the method 300 terminates. Notably, any number of instances of the origin application 160 can execute method 300 concurrently, where each instance of the origin application 160 stores segments and manifests received from the streaming pipelines in a different region of the memory and can retrieve segments and manifests from that “local” region and any number of other “remote” regions of the memory.

In sum, the disclosed techniques can be used to stream live events. In some embodiments, a system includes a preferred streaming pipeline, an alternate streaming pipeline, two origin servers, a memory, an orchestrator, a CDN, and any number of client devices. Throughout a live event, the preferred streaming pipeline generates preferred versions of segments and manifests based on one or more live media feeds associated with the live event and transmits the preferred versions of the segments and the manifests to both origin servers. Concurrently, the alternate streaming pipeline generates alternate versions of segments and manifests based on the same live media feed(s) and transmits the alternate versions of the segments and the manifests to both origin servers. Each origin server executes a different instance of an origin application that stores received segments and manifests in a different region of the memory that is considered a “local region” with respect to that instance of the origin application and is considered a “remote region” with respect to the other instance of the origin application.

Prior to the start of the live event, each origin application receives a publishing configuration from the orchestrator. The publishing configuration includes any amount and types of metadata that enable the origin application to detect various errors (e.g., timing discontinuities, late arrival times, incorrect duration) in segments and manifests associated with the live event. Throughout the live event, the origin application delivers, on-demand, segments and manifests associated with any number of live events to client devices via the CDN.

Upon receiving a request from the CDN for an object (e.g., a segment or a manifest) for the live event, the origin application attempts to retrieve from the local region of the memory a preferred version of the requested object. If the origin application is unable to retrieve the preferred version of the requested object from the local region of the memory, then the origin application attempts to retrieve the preferred version of the requested object from the remote region of the memory. If the origin application is able to retrieve the preferred version of the requested object from either region of the memory, then the origin application performs one or more error checks on the preferred version of the requested object based on the publishing configuration. If the preferred version of the requested object does not include any errors, then the origin application generates and transmits to the CDN a response that includes the preferred version of the requested object.

If the origin application is unable to retrieve the preferred version of the requested object from either region of the memory or the preferred version of the requested object includes one or more errors, then the origin application attempts to retrieve the alternate version of the requested object from the local region of the memory. If the origin application is unable to retrieve the alternate version of the requested object from the local region of the memory, then the origin application attempts to retrieve the alternate version of the requested object from the remote region of the memory. If the origin application is able to retrieve the alternate version of the requested object from either region of the memory, then the origin application performs one or more error checks on the alternate version of the requested object based on the publishing configuration. If the alternate version of the requested object does not include any errors, then the origin application generates and transmits to the CDN a response that includes the alternate version of the requested object.

If the origin application is unable to retrieve either version of the requested object from either region of the memory, then the origin application generates and transmits to the CDN a response indicating that the requested object was not found. If, however, each retrieved version of the requested object includes one or more errors, then the origin application selects one of the retrieved version(s) of the requested object. The origin application then performs any number and/or types of error concealment and/or repair operations on the selected version of the requested object to generate a new version of the requested object. The origin application generates and transmits to the CDN a response that includes the new version of the requested object.

At least one technical advantage of the disclosed techniques relative to the prior art is that, with the disclosed techniques, the number of segments having errors that are delivered to client devices via a CDN can be reduced. Accordingly, implementing the disclosed techniques can substantially improve the overall viewing quality experienced by users of client devices who are watching a live event. In that regard, with the disclosed techniques, if a preferred version of a requested segment exists but includes one or more errors and an alternate version of the requested segment exists and is error-free, then the alternate version of the requested segment is delivered to the client devices via the CDN instead of the preferred version. As a result, with the disclosed techniques, the number of segments having errors that are ultimately delivered to client devices can be reduced relative to prior art techniques that preferentially deliver preferred versions of segments irrespective of any errors included in the preferred versions of the segments. These technical advantages provide one or more technological advancements over prior art approaches.

1. In some embodiments, a computer-implemented method for streaming live events comprises determining that a first version of a first segment of a stream that is associated with a live event includes one or more errors; in response, retrieving from a first memory a second version of the first segment; determining that the second version of the first segment does not include any errors; and transmitting the second version of the first segment to a content delivery network (CDN).

2. The computer-implemented method of clause 1, wherein determining that the first version of the first segment includes one or more errors comprises comparing a total number of frames included in the first version of the first segment to an expected number of frames per segment.

3. The computer-implemented method of clauses 1 or 2, wherein determining that the first version of the first segment includes one or more errors comprises comparing a first start time associated with the first version of the first segment to an expected start time for the first segment.

4. The computer-implemented method of any of clauses 1-3, wherein retrieving the first version of the first segment from the first memory comprises retrieving the first version of the first segment from a second region of the first memory after failing to retrieve the first version of the first segment from a first region of the first memory.

5. The computer-implemented method of any of clauses 1-4, further comprising, prior to determining that the first version of the first segment includes one or more errors, receiving the first version of the first segment from a first streaming pipeline; receiving the second version of the first segment from a second streaming pipeline; and storing in the first memory both the first version of the first segment and the second version of the first segment.

6. The computer-implemented method of any of clauses 1-5, further comprising determining that a first version of a second segment of the stream and at least a second version of the second segment of the stream include one or more errors; performing one or more error concealment operations on the first version of the second segment to generate a modified version of the second segment; and transmitting the modified version of the second segment to the CDN.

7. The computer-implemented method of any of clauses 1-6, wherein the stream comprises a video stream, and the one or more error concealment operations comprise inserting one or more replicated frames into the first version of the second segment of the stream.

8. The computer-implemented method of any of clauses 1-7, further comprising determining that a first version of a first manifest associated with the live event includes one or more errors; in response, retrieving from the first memory a second version of the first manifest; determining that the second version of the first manifest does not include any errors; and transmitting the second version of the first manifest to the CDN.

9. The computer-implemented method of any of clauses 1-8 wherein the first manifest comprises a window manifest that describes a first portion of the stream or an event manifest that describes the first portion of the stream and at least a second portion of the stream.

10. The computer-implemented method of any of clauses 1-9, further comprising determining that a first version of a first manifest associated with the live event and at least a second version of the first manifest includes one or more errors; performing one or more error concealment operations on the first version of the first manifest to generate a repaired version of the first manifest; and transmitting the repaired version of the first manifest to the CDN.

11. In some embodiments, one or more non-transitory computer readable media include instructions that, when executed by one or more processors, cause the one or more processors to stream live events by performing the steps of determining that a first version of a first segment of a stream that is associated with a live event includes one or more errors; in response, retrieving from a first memory a second version of the first segment; determining that the second version of the first segment does not include any errors; and transmitting the second version of the first segment to a content delivery network (CDN).

12. The one or more non-transitory computer readable media of clause 11, wherein determining that the first version of the first segment includes one or more errors comprises comparing a total number of frames included in the first version of the first segment to an expected number of frames per segment.

13. The one or more non-transitory computer readable media of clauses 11 or 12, wherein determining that the first version of the first segment includes one or more errors comprises detecting that the first version of the first segment has at least one of a timing discontinuity or an incorrect number of frames.

14. The one or more non-transitory computer readable media of any of clauses 11-13, wherein retrieving the first version of the first segment from the first memory comprises retrieving the first version of the first segment from a second region of the first memory after failing to retrieve the first version of the first segment from a first region of the first memory.

15. The one or more non-transitory computer readable media of any of clauses 11-14 further comprising, in further response to determining that the first version of the first segment includes one or more errors, generating an error message indicating that a first streaming pipeline is compromised.

16. The one or more non-transitory computer readable media of any of clauses 11-15, further comprising determining that a first version of a second segment of the stream and at least a second version of the second segment of the stream include one or more errors; performing one or more error concealment operations on the first version of the second segment to generate a modified version of the second segment; and transmitting the modified version of the second segment to the CDN.

17. The one or more non-transitory computer readable media of any of clauses 11-16, wherein the stream comprises an audio stream, and the one or more error concealment operations comprise inserting a portion of silent audio into the first version of the second segment of the stream.

18. The one or more non-transitory computer readable media of any of clauses 11-17, further comprising determining that a first version of a first manifest associated with the live event includes one or more errors; in response, retrieving from the first memory a second version of the first manifest; determining that the second version of the first manifest does not include any errors; and transmitting the second version of the first manifest to the CDN.

19. The one or more non-transitory computer readable media of any of clauses 11-18, further comprising generating an event manifest associated with the live event based on the second version of the first manifest and a first version of a second manifest, wherein the first manifest is associated with a first period of time and the second manifest is associated with a second period of time.

20. In some embodiments, a system comprises one or more memories storing instructions and one or more processors coupled to the one or more memories that, when executing the instructions, perform the steps of determining that a first version of a first segment of a stream that is associated with a live event includes one or more errors; in response, retrieving from a first memory a second version of the first segment; determining that the second version of the first segment does not include any errors; and transmitting the second version of the first segment to a content delivery network (CDN).

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory, Flash memory, an optical fiber, a portable compact disc read-only memory, an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for streaming live events, the method comprising:
determining that a first version of a first segment of a stream that is associated with a live event includes one or more errors;
in response, retrieving from a first memory a second version of the first segment;
determining that the second version of the first segment does not include any errors; and
transmitting the second version of the first segment to a content delivery network (CDN).

2. The computer-implemented method of claim 1, wherein determining that the first version of the first segment includes one or more errors comprises comparing a total number of frames included in the first version of the first segment to an expected number of frames per segment.

3. The computer-implemented method of claim 1, wherein determining that the first version of the first segment includes one or more errors comprises comparing a first start time associated with the first version of the first segment to an expected start time for the first segment.

4. The computer-implemented method of claim 1, wherein retrieving the first version of the first segment from the first memory comprises retrieving the first version of the first segment from a second region of the first memory after failing to retrieve the first version of the first segment from a first region of the first memory.

5. The computer-implemented method of claim 1, further comprising, prior to determining that the first version of the first segment includes one or more errors:
receiving the first version of the first segment from a first streaming pipeline;
receiving the second version of the first segment from a second streaming pipeline; and
storing in the first memory both the first version of the first segment and the second version of the first segment.

6. The computer-implemented method of claim 1, further comprising:
determining that a first version of a second segment of the stream and at least a second version of the second segment of the stream include one or more errors;
performing one or more error concealment operations on the first version of the second segment to generate a modified version of the second segment; and
transmitting the modified version of the second segment to the CDN.

7. The computer-implemented method of claim 6, wherein the stream comprises a video stream, and the one or more error concealment operations comprise inserting one or more replicated frames into the first version of the second segment of the stream.

8. The computer-implemented method of claim 1, further comprising:
determining that a first version of a first manifest associated with the live event includes one or more errors;
in response, retrieving from the first memory a second version of the first manifest;
determining that the second version of the first manifest does not include any errors; and
transmitting the second version of the first manifest to the CDN.

9. The computer-implemented method of claim 8, wherein the first manifest comprises a window manifest that describes a first portion of the stream or an event manifest that describes the first portion of the stream and at least a second portion of the stream.

10. The computer-implemented method of claim 1, further comprising:
determining that a first version of a first manifest associated with the live event and at least a second version of the first manifest includes one or more errors;
performing one or more error concealment operations on the first version of the first manifest to generate a repaired version of the first manifest; and
transmitting the repaired version of the first manifest to the CDN.

11. One or more non-transitory computer readable media including instructions that, when executed by one or more processors, cause the one or more processors to stream live events by performing the steps of:
determining that a first version of a first segment of a stream that is associated with a live event includes one or more errors;
in response, retrieving from a first memory a second version of the first segment;
determining that the second version of the first segment does not include any errors; and
transmitting the second version of the first segment to a content delivery network (CDN).

12. The one or more non-transitory computer readable media of claim 11, wherein determining that the first version of the first segment includes one or more errors comprises comparing a total number of frames included in the first version of the first segment to an expected number of frames per segment.

13. The one or more non-transitory computer readable media of claim 11, wherein determining that the first version of the first segment includes one or more errors comprises detecting that the first version of the first segment has at least one of a timing discontinuity or an incorrect number of frames.

14. The one or more non-transitory computer readable media of claim 11, wherein retrieving the first version of the first segment from the first memory comprises retrieving the first version of the first segment from a second region of the first memory after failing to retrieve the first version of the first segment from a first region of the first memory.

15. The one or more non-transitory computer readable media of claim 11, further comprising, in further response to determining that the first version of the first segment includes one or more errors, generating an error message indicating that a first streaming pipeline is compromised.

16. The one or more non-transitory computer readable media of claim 11, further comprising:
determining that a first version of a second segment of the stream and at least a second version of the second segment of the stream include one or more errors;
performing one or more error concealment operations on the first version of the second segment to generate a modified version of the second segment; and
transmitting the modified version of the second segment to the CDN.

17. The one or more non-transitory computer readable media of claim 16, wherein the stream comprises an audio stream, and the one or more error concealment operations comprise inserting a portion of silent audio into the first version of the second segment of the stream.

18. The one or more non-transitory computer readable media of claim 11, further comprising:
determining that a first version of a first manifest associated with the live event includes one or more errors;
in response, retrieving from the first memory a second version of the first manifest;
determining that the second version of the first manifest does not include any errors; and
transmitting the second version of the first manifest to the CDN.

19. The one or more non-transitory computer readable media of claim 18, further comprising generating an event manifest associated with the live event based on the second version of the first manifest and a first version of a second manifest, wherein the first manifest is associated with a first period of time and the second manifest is associated with a second period of time.

20. A system comprising:
one or more memories storing instructions; and
one or more processors coupled to the one or more memories that, when executing the instructions, perform the steps of:
determining that a first version of a first segment of a stream that is associated with a live event includes one or more errors;
in response, retrieving from a first memory a second version of the first segment;
determining that the second version of the first segment does not include any errors; and
transmitting the second version of the first segment to a content delivery network (CDN).
